(19) United States
(12) Patent Application Publication
(10) Pub. No.: US 2002/0080999 A1
(43) Pub. Date: Jun. 27, 2002

(54) System and method for highlighting a scene under vision guidance

(76) Inventors: Ali Bani-Hashemi, Walnut Creek, CA (US); Nassir Navab, Plainsboro, NJ (US)

Correspondence Address: Siemens Corporation, Intellectual Property Department, 186 Wood Avenue South, Iselin, NJ, 08830, US

(21) Appl. No.: 10/001,552

(22) Filed: Oct. 31, 2001

Related U.S. Application Data
(60) Provisional application No. 60/245,508, filed on Nov. 3, 2000.

(51) Int. Cl. G06K 9/00

(52) U.S. Cl. 382/103

(57) ABSTRACT

A system and method for illuminating a target point in a real scene comprises an image capture device for capturing image data of a scene, an illumination device for projecting a beam of light at a target point in the scene; and a data processing device comprising computer readable program code embodied therein for processing image data associated with the target point and generating control signals to control the illumination system to direct a beam of light at the target point in the scene. Preferably, the imaging system and illumination system comprise an integrated system wherein the optical path for image formation is identical to that of light projection, so as to eliminate occlusion and eliminate the need for calibration.

### CROSS-REFERENCE TO RELATED APPLICATION

This application claims priority from U.S. Provisional Patent Application Serial No. 60/245,508, filed on Nov. 3, 2000, which is fully incorporated herein by reference.

### BACKGROUND

The present invention relates generally to systems and methods for imaging processing and, in particular, to systems and methods for processing coordinates of a target point in a captured image of a real scene and converting the image coordinates to coordinates of a light projector to illuminate the target point.

The application and scenario, which has inspired us to think and consequently come up with this invention is as follows. Suppose an expert, who is located at a remote site, wants to instruct another person to perform a task. For example, the expert may assist a technician at a remote location to perform a repair or assembly operation, or the expert may assist a doctor at a remote location to perform a surgery. Assume further that an electronic camera (video camera) is set up at the remote location to monitor the scene (e.g., the repair, assembly, operation, etc.), wherein the images are digitized and captured by a computer and the digital image/video is remotely displayed to the expert. Although the expert can remotely witness the repair, etc, and provide verbal guidance, it may be difficult for the technician, surgeon, etc. to understand what component, location, etc; the expert is referring to during the repair, etc.

Thus, in the above scenario, it would be highly desirable for a system and method that would allow the expert to be able to physically identify an object, location, etc, in the physical scene to further assist the technician. For instance, an apparatus that would allow the expert to select a target point in the image and automatically point a beam of light (e.g., laser) to illuminate the target point, would help the technician at the remote site to understand what the expert is referring to.

### SUMMARY OF THE INVENTION

The present invention is directed to systems and methods for illuminating a target point in a real scene using image data of the scene. In one aspect, a method for illuminating a target point in a real scene comprises the steps of capturing image data of a scene, identifying image data associated with a target point in the scene, and projecting a light beam at the target point in the real scene using the image data associated with the target point. The step of projecting comprises the steps of converting image coordinates of the target point to light coordinates for directing the light beam, and processing the light coordinates to direct the light beam to the target point in the real scene.

In another aspect, a system for illuminating a target point in a real scene comprises an image capture device for capturing image data of a scene, an illumination device for projecting a beam of light at a target point in the scene; and a data processing device comprising computer readable program code embodied therein for processing image data associated with the target point and generating control signals to control the illumination system.

In yet another aspect, the image capture device and the illumination device comprise common optical properties and/or comprise an integrated device.

In another aspect, the illumination device comprises a light-emitting plane having an array of point sources, wherein the data processing device generates control signals for activating a point source in the light-emitting plane that corresponds to a projection of the target point on the light-emitting plane.

In yet another aspect, the illumination device comprises a laser beam device. The laser beam device preferably comprises a laser beam generator, a deflector for deflecting the laser beam emitted from the laser beam generator, and a plurality of motors, operatively connected to the deflector, for positioning the deflector to deflect the laser beam to the target point. The data processing device comprises computer readable program code embodied therein for generating control signals to control the plurality of motors to position the deflector at an appropriate angle.

In another aspect, the image capture device comprises an omni-directional camera.

These and other objects, features and advantages of the present invention will be described or become apparent from the following detailed description of preferred embodiments, which is to be read in connection with the accompanying drawings.

### BRIEF DESCRIPTION OF DRAWINGS

FIG. 1 is a high-level diagram of a system for illuminating a target point in a real scene using image data of the scene, according to an embodiment of the present invention;

FIGS. 2a and 2b illustrate principles of an optics model according to an embodiment of the present invention;

FIG. 3 is a schematic diagram of an apparatus comprising a camera and light projector for illuminating a target point in a real scene using image data of the scene, according to an embodiment of the present invention;

FIG. 4 is a schematic diagram of an apparatus comprising a camera and laser system for illuminating a target point in a real scene using image data of the scene, according to an embodiment of the present invention; and

FIG. 5 is a schematic diagram of an apparatus comprising an omni-directional camera and laser for illuminating a target point in a real scene using image data of the scene, according to an embodiment of the present invention.

### DETAILED DESCRIPTION OF PREFERRED EMBODIMENTS

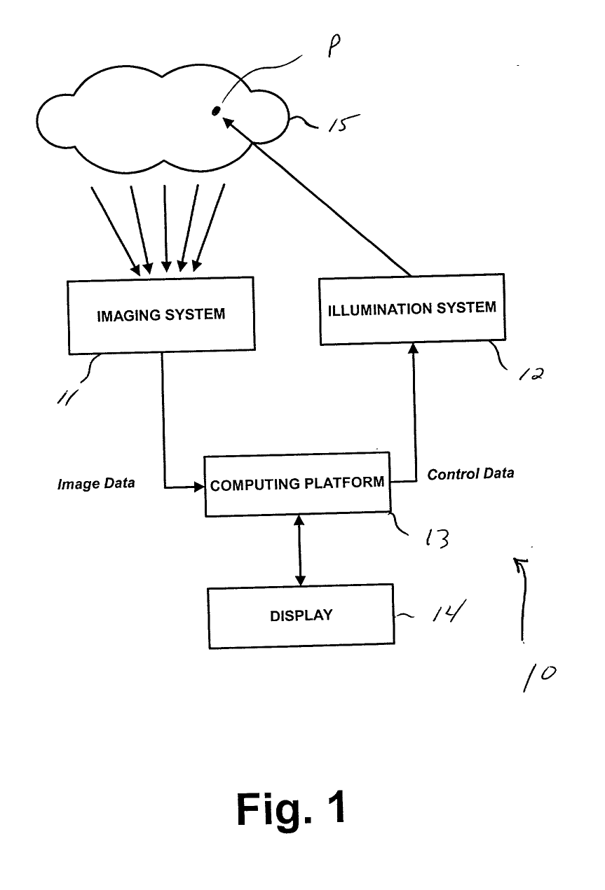

FIG. 1 is a high-level diagram of a system for illuminating a target point in a real scene using image data of the scene, according to an embodiment of the present invention. In general, system 10 comprises an imaging system 11, an illumination system 12, a data processing platform 13 (such as a personal computer or any other computer-based platform comprising suitable architecture) and a display 14 (e.g., computer monitor). The imaging system 11 (e.g., video camera) comprises a lens and other optical components for capturing an image of a physical scene 15. The imaging system 11 generates 2-dimensional (2D) image data from the captured image using any suitable method known in the art. The 2D image data is received and processed by the computing platform 13, which preferably displays the captured image on display 14.

The computing platform 13 processes the image data to identify a user-selected target point P in the real scene 15. For example, in one embodiment, a user can select a target point in the displayed image using, e.g., a pointing device such as a mouse. Once the target point P (in the image plane) is identified, the computing platform 13 will generate corresponding control data that is transmitted to the illumination system 12. The illumination system 12 processes the control data to direct a beam of light that intersects and illuminates the identified target point P in the real world scene 15. The computing platform 13 executes an image processing and detection application that automatically converts the coordinates of a selected target point in the captured image to coordinates of a light projector to illuminate the target.

In a preferred embodiment, the imaging system 11 and illumination system 12 comprise an integrated system, wherein the optics of the imager (camera and lens) is identical (by design) to the optics used for light projector (laser, for example). An integrated design allows the optical path for image formation to be identical to that of light projection, which consequently, affords various advantages. For instance, an integrated design eliminates the need for calibration. Further, the integrated design eliminates the problem of occlusion due to the unique optical paths between the imager and the light-projector. Occlusion would be an issue if a point visible to the camera is hidden from the projector, however, identical optical paths automatically eliminate this problem.

The multitude of applications in which the present invention may be implemented is readily apparent to those skilled in the art. For instance, in the above-described scenario, an expert who is located at a remote site can instruct a technician to perform a repair or an assembly operation. A smart video camera comprising a combination imaging and illumination system can be used to monitor the site of the repair or assembly. The images are digitized and captured by the smart camera or a computer. The digital image/video data is transmitted to a remote location for display. The expert may select a target in the image (e.g., the expert can indicate a point on the screen, for example by means of putting a cursor on the computer screen), which then causes the illumination system to generate a beam of light that intersects (highlights) the selected target.

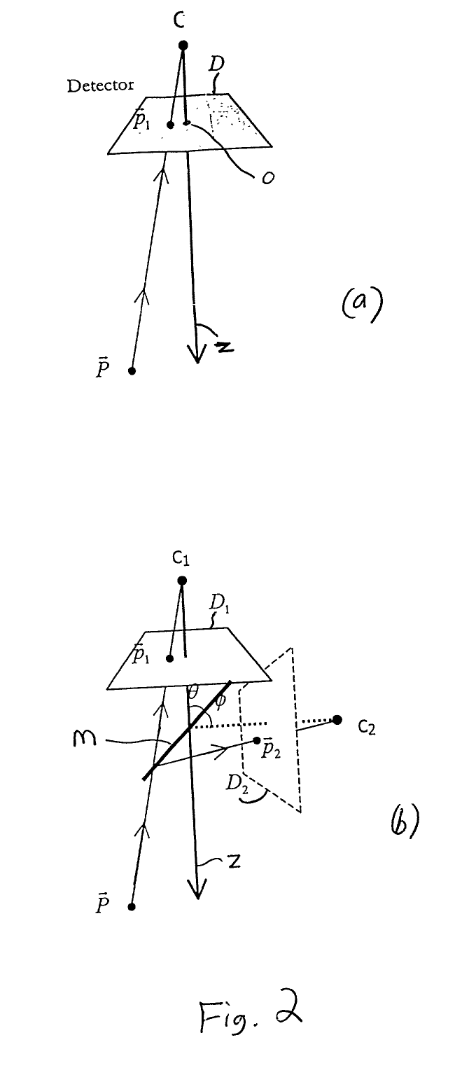

The diagrams of FIGS. 2a and 2b illustrate a projection model according to an embodiment of the present invention, which is preferably implemented in the system of FIG. 1. FIG. 2a illustrates a model of a camera, as well as a method of image formation. With a camera model, the center of a coordinate frame is deemed to be the projection center of the camera (denoted as C). More specifically, a principal axis (Z axis) extends perpendicularly from point C to detector plane D of the camera detector. The intersection of the Z axis (principal axis) with the detector plane D is defined to be the image center O. The X and Y axes are parallel to the image plane, e.g., the column and row vectors of the image (respectively) forming the image coordinate frame on the detector plane D. The distance from the projection center C to point O on the image plane is the focal length f.

The image of a point \vec{P} corresponds to a point \vec{P}₁ on the detector plane D. In particular, a ray connecting the 3D point \vec{P} to the center point C intersects the detector plane D at the image point \vec{P}₁. The image point \vec{P}₁ is defined to be the perspective projection of the 3D point \vec{P}.

The diagram of FIG. 2b illustrates an extension of the camera projection model of FIG. 2a to generate a projection model according to the present invention. FIG. 2b illustrates a reflection of projection center C₁ and image plane D₁ with respect to a mirror M placed on the optical path of the first camera with, e.g., 2=N=45 degree angle. The mirror M reflects the projection center C₁ and the detector plane D₁ to virtual projection center C₂ and a virtual detector plane D₂. If a second camera, identical to the first camera, is placed with its projection center at C₂ and its detector plane at D₂, the image formed by the second camera will be identical to the image formed by the first camera.

Furthermore, if the mirror M comprises a half mirror (or beam splitter), and assuming two identical cameras with focal points of C₁ and C₂, the images from these two cameras will be identical.

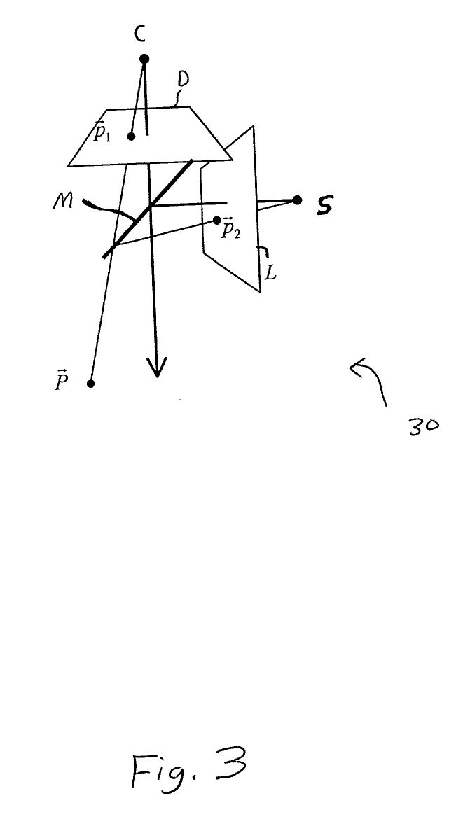

Using the above projection models, various embodiments may be realized for automatic highlighting of a scene under vision guidance according to the present invention. For example, FIG. 3 is a schematic diagram of an apparatus for illuminating a target point in a real scene using image data of the scene, according to an embodiment of the present invention. In the illustrative embodiment of FIG. 3, the second camera of FIG. 2b is replaced with a projector system comprising optical properties that are virtually identical to the optical properties of the first camera. An apparatus 30 comprises a camera and a light projector. As shown in FIG. 3, a light projector, which comprises a light-emitting plane L (a special planar illuminator), has a projection center at source S. The light-emitting plane L may comprise, for example, an array of active point light sources, wherein each active element on the light-emitting plane L corresponds to a pixel on the detector plane D of the camera.

One way of realizing such projector is to imagine that every point on the detector D can become a bright point. More specifically, assume that 3D point \vec{P} in a physical scene forms an image on the image plane D of the camera at point \vec{p}₁. Assume further that \vec{p}₂ is a point on the light-emitting plane L that corresponds to the perspective projection of the 3D point \vec{P} on the plane L by virtue of mirror M. If point \vec{p}₂ on the light-emitting plane L is activated (meaning turning the point into a point source), then a light beam corresponding to the point \vec{p}₂ can illuminate the target point \vec{P}.

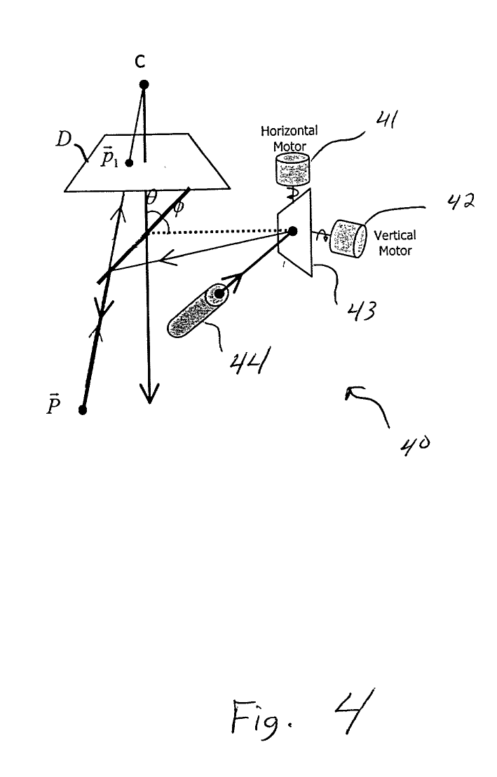

FIG. 4 is a schematic diagram of an apparatus comprising a camera and laser system for illuminating a target point in a real scene using image data of the scene, according to another embodiment of the present invention. In the illustrative embodiment of FIG. 4, an illumination component of apparatus 40 comprises a laser beam projector system. The laser beam projector system comprises a laser beam deflector 43(mirror) that is controlled by several galvanometers (41, 42) to reflect a laser beam emitted from laser 44. The deflector 43 pivots around the horizontal and vertical axes under the control of motor 41 and motor 42, respectively. The x and y axes are similar to the row and column axes of the illuminating plane L, as described above in FIGS. 2 and 3.

In the illustrative embodiment of FIG. 4, under the control of an application executing on a suitable computer platform, the coordinates of a target point \vec{p}₁ in the image plane D (which correspond to an image of a 3D point \vec{P} in the scene) are first identified, and then such coordinates are processed to determine the horizontal and vertical deflection angles and generate necessary control signals that position the laser deflector 43 under control of the two galvanometers 41 and 42. In this embodiment, the center of rotation of the laser-deflecting mirror 43 comprises the reflection of the projection center of Camera (i.e., point C). Then, once the laser deflector 43 is properly positioned, the laser light emitted from laser 44 against the deflector 43 can be appropriately guided/reflected to illuminate the target point in the real world.

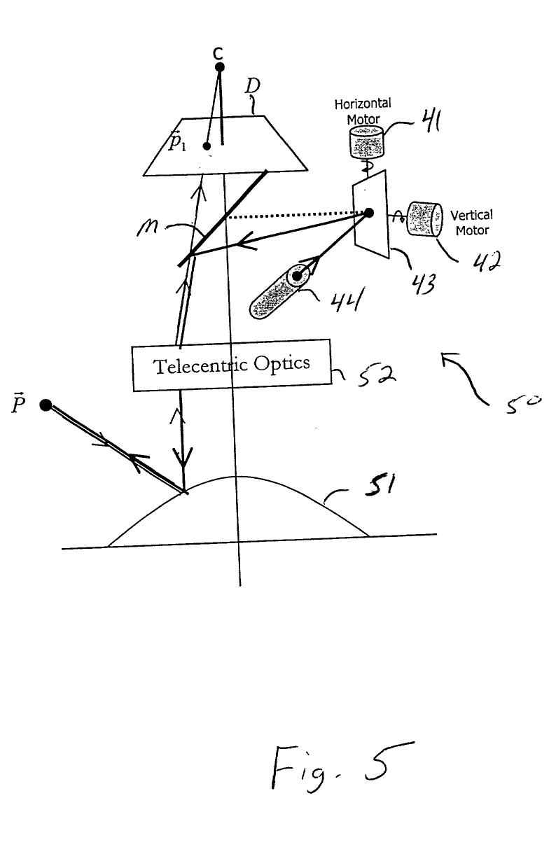

FIG. 5 is a schematic diagram of an apparatus for illuminating a target point in a real scene using image data of the scene, according to another embodiment of the present invention. In FIG. 5, an apparatus 50 comprises an omni-directional camera and laser. Various embodiments of omni-directional cameras are known in the art such as the imaging devices described by S. Nayar, “Omnidirectional Video Camera”, Proceedings of DARPA Image Understanding Workshop, New Orleans, May 1997. In such systems, one or multiple cameras are utilized to have an omni-directional view of the scene. In each of these designs, the imager system (video camera along with its optics) may be replaced by a combination imager and light projector in accordance with the principles of the present invention.

For example, the embodiment of FIG. 5 preferably comprises a laser-based light projector in combination with an omni-directional camera such as a catadioprtic imager (which is described in the reference by Nayar). The apparatus 50 comprises a catadioptric imaging system (which uses a reflecting surface (mirror) to enhance the fields of view), comprising a parabolic mirror 51 viewed by a video camera mounted telecentric lens 52. In the exemplary embodiment of FIG. 5, the light projector (the laser based projector in this case) is positioned in the optic path to realize the combination of imager and the projector. In another embodiment, the light projector may be placed between the telecentric optics 52 and the parabolic mirror 51.

The use of the omni-directional camera affords an added advantage of providing a viewing/operating space in a 180 or 360 degrees field of view. Such cameras project the entire hemisphere (for a 180 degree view or two hemispheres for a 360 degree view) onto a plane. This creates a warped/distorted picture that can be un-warped (by a suitable image processing protocol) to view the scene from any direction.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention. All such changes and modifications are intended to be included within the scope of the invention as defined by the appended claims.

What is claimed is:

1. A method for illuminating a target point in a real scene, comprising the steps of:
capturing image data of a scene;
identifying image data associated with a target point in the scene; and
projecting a light beam at the target point in the real scene using the image data associated with the target point.

2. The method of claim 1, wherein the step of projecting comprises the steps of:
converting image coordinates of the target point to light coordinates for directing the light beam; and
processing the light coordinates to direct the light beam to the target point in the real scene.

3. The method of claim 1, wherein an integrated optical device is used for performing the steps of image capture and light projection.

4. The method of claim 1, wherein the step of projecting a light beam comprises projecting a laser beam.

5. The method of claim 1, wherein the step of capturing image data is performed using an omni-directional camera.

6. The method of claim 1, wherein the step of identifying image data associated with a target point in the scene, comprises the steps of:
displaying the scene; and
selecting a target point in the scene using the displayed scene.

7. A program storage device readable by a machine, tangibly embodying a program of instructions executable by the machine to perform method steps for illuminating a target point in a real scene, the method steps comprising:
capturing image data of a scene;
identifying image data associated with a target point in the scene; and
projecting a light beam at the target point in the real scene using the image data associated with the target point.

8. The program storage device of claim 7, wherein the instructions for projecting comprise instructions for performing the steps of:
converting image coordinates of the target point to light coordinates for directing the light beam; and
processing the light coordinates to direct the light beam to the target point in the real scene.

9. The program storage device of claim 7, wherein the instructions for identifying image data associated with a target point in the scene comprise instructions for performing the steps of:
displaying the scene; and
receiving as input, image coordinates of a user-selected a target point in the displayed scene.

10. A system for illuminating a target point in a real scene, comprising:
an image capture device for capturing image data of a scene;
an illumination device for projecting a beam of light at a target point in the scene; and a
data processing device comprising computer readable program code embodied therein for processing image data associated with the target point and generating control signals to control the illumination system.

11. The system of claim 10, wherein the image capture device and the illumination device comprise common optical properties.

12. The system of claim 10, wherein the image capture device and the illumination device comprise an integrated device.

13. The system of claim 10, wherein the illumination device comprises a light-emitting plane.

14. The system of claim 14, wherein the data processing device comprises computer readable program code embodied therein for activating a point source in the light-emitting plane that corresponds to a projection of the target point on the light-emitting plane.

15. The system of claim 10, wherein the illumination device comprises a laser beam device.

16. The system of claim 15, wherein the laser beam device comprises:
a laser beam generator;
a deflector for deflecting the laser beam emitted from the laser beam generator;
a plurality of motors, operatively connected to the deflector, for positioning the deflector to deflect the laser beam to the target point.

17. The system of claim 16, wherein the data processing device comprises computer readable program code embodied therein for generating control signals to control the plurality of motors to position the deflector at an appropriate angle.

18. The system of claim 10, wherein the image capture device comprises an omni-directional camera.

19. The system of claim 10, further comprising a display device for displaying the scene, wherein selecting a point on the displayed scene identifies a target point.
